(19) United States
(12) Patent Application Publication
(10) Pub. No.: US 2020/0386389 A1
(43) Pub. Date: Dec. 10, 2020

(54) EYE-FRIENDLY ILLUMINATION SPOTLIGHT USED FOR CLEANING THE BABY'S EXCRETA AT NIGHT

(71) Applicant: Zhao TUO, Jining City (CN)

(72) Inventor: Zhao TUO, Jining City (CN)

(21) Appl. No.: 16/549,865

(22) Filed: Aug. 23, 2019

(30) Foreign Application Priority Data
Jun. 5, 2019 (CN) 201910485900.2

(51) Int. Cl. F21V 23/00; F21V 3/00; F21V 23/04

(52) U.S. Cl. CPC F21V 23/004; F21Y 2115/10; F21V 23/04; F21V 3/00

(57) ABSTRACT

The present invention relates to an eye-friendly illumination spotlight used for cleaning the baby's excreta at night, comprising an open box body with an opening at bottom, the bottom opening of the open box body being mounted with a detachable bottom cover, wherein the open box body comprises a front side of the box body detachably arranged on the open box body, the inner wall of the front side of the box body is fixedly provided with a first luminous assembly and a second luminous assembly arranged symmetrically, the lighting path of the first luminous assembly intersects the lighting path of the second luminous assembly to form an X-shaped lighting path. The present invention has the following benefits: the lighting is good for shining the baby's buttocks and is dispersed and reduced rapidly after clustering. When using, it will not cause a direct shining the baby's eyes, and will not affect the baby's sleeping, more will not injure the baby's vision. It can meet the requirements of the lighting for parents changing the nappy at night and cleaning the baby's extract, and is convenient to use.

### CROSS-REFERENCE TO RELATED APPLICATIONS

This application claims the benefit of foreign priority to China Application No. 201910485900.2, filed on Jun. 5, 2019 by at least one common inventor, which is incorporated by reference herein in its entirety.

### TECHNICAL FIELD

The present invention relates to an eye-friendly illumination spotlight used for cleaning the baby's excreta at night, belonging to the field of illumination spotlight.

### BACKGROUND ART

An illuminant for cleaning is an unknown filed that has not been explored when the baby is needed to change the nappy and do cleaning at night. When cleaning the baby's excrement at night, parents need a suitable and clear illuminant. At present the normal lightning methods are: 1. using room lamp; 2. using mobile phone lamp; 3. using a power night lamp; 4. using other illuminant such as floor lamp and desk lamp. However above 4 lightning methods have disadvantages.

1. Turning on the room lamp, the room suddenly becomes bright, due to the baby's pupils dilate at night, the room lamp is too bright to cause the eyes discomfort. And it need several minutes for cleaning and changing the nappy, turning on the room lamp will excite the baby, so as to be difficult to fall asleep again quickly.

2. Using mobile phone lamp, the mobile phone is not easy to fix when changing nappy, if the mobile phone is held in one hand, it is difficult to change the nappy with the other hand. And the mobile phone lamp is a single strong light, the baby's pupils dilate at night, if shining the baby's eye, it will injure the baby's vision. There is a case that baby lost its sight when a relative taking a picture of the baby in the dark because he forgot to turn off the flash. The reason is: the eyes of the baby are particularly weak, not yet forming macular and opacification lens, which cannot be excited by the strong light.

3. Using power night lamp, the night lamp on the wall can meet the requirement of getting up at night, but it can't meet the requirement of cleaning the baby's buttocks. Many babies suffer from lactose intolerance in the first few months, and their excreta is acidic. If they are not cleaned up properly, the acid covering the skin will burn the buttocks and cause burns. It is the main reason why the babies have red hips when they use nappy in early.

4. Because the shape of the baby's buttocks shows V-shape, using the illuminant such as the floor lamp and the desk lamp, requirement of the light angle is severe, it will cause inconvenience when using. Sum up, there is no good product for parents cleaning their babies at night.

### DISCLOSURE OF INVENTION

According to disadvantages in prior art, the technical problem to be solved in present invention is: apply an eye-friendly illumination spotlight used for cleaning the baby's excreta at night in order to solve one of above problems.

The present invention relates to an eye-friendly illumination spotlight used for cleaning the baby's excreta at night, comprising an open box body with an opening at bottom, the bottom opening of the open box body being mounted with a detachable bottom cover, wherein the open box body comprises a front side of the box body detachably arranged on the open box body, the inner wall of the front side of the box body is fixedly provided with a first luminous assembly and a second luminous assembly arranged symmetrically, a front side of the box body comprise the transparent window A which coordinate with the lighting path of the first luminous assembly and the transparent window B which coordinate with the lighting path of the second luminous assembly, the lighting path of the first luminous assembly intersects the lighting path of the second luminous assembly to form an X-shaped lighting path, those two lighting path become the cluster point which is in the front of the product.

The two precise lighting paths of the first luminous assembly and the second luminous assembly is interested and distributed as an X shaped. Preferably, the two lighting paths may intersect an X-shaped lighting path 20-25 cm in front of the open box body. If the box is placed in front of the baby's buttocks, the cluster point is formed near the baby's buttocks. For V-shape of the baby's buttocks, two interested lighting path can achieve the best effect. The lighting is good for shining the baby's buttocks and is dispersed and reduced rapidly after clustering. When using, it will not cause a direct shining the baby's eyes, and will not affect the baby's sleeping, more will not injure the baby's vision. It can meet the requirements of the lighting for parents changing the nappy at night and cleaning the baby's extract, and is convenient to use.

Preferably, wherein the front side of the box body comprises an illuminant loading plate, two ends and the top of the illuminant loading plate are respectively arranged with a first insert plate, a second insert plate and a third insert plate, the open box body is arranged with the illuminant loading plate slots connected with the first insert plate, the second insert plate and the third insert plate.

Preferably, wherein the first luminous assembly comprises a PCB plate A arranged inside the open box body and equipped with a control circuit to control the illuminant, an illuminant A connected with the PCB plate A, and a lens A clamped between the illuminant loading plate and the PCB plate A to gather the light beam of the illuminant A for irradiation; the second luminous assembly comprises a PCB plate B arranged inside the open box body and equipped with a control circuit to control the illuminant, an illuminant B connected with the PCB plate B, and a lens B clamped between the illuminant loading plate and the PCB plate B to gather the light beam of the illuminant B for irradiation.

Preferably, wherein the illuminant A is a lamp bead A, the illuminant B is a lamp bead B, the lamp bead A and the lamp bead B are LED beads, the color temperature of LED beads is less than 3000K, the light is warm and soft, which is helpful to reduce eye irritation at night.

Preferably, wherein the PCB plate A and the PCB plate B are detachably mounted on the illuminant loading plate respectively through the corresponding PCB plates and the lens positioning column.

Preferably, wherein the transparent window A is integrated with a light shield A, the light shield A is located on the illuminant loading plate, the transparent window B is integrated with a light shield B, the light shield B is located on the illuminant loading plate, the light shield A and the light shield B further integrate the light path from the lens and filter stray light, so that the lighting path of the first luminous assembly and the lighting path of the second luminous assembly project more accurately.

Preferably, wherein the inner wall of the bottom cover is provided with a DC power for providing energy for the lamp beads A and B, the lamp beads A and B are electrically connected with the DC power, the back side of the open box body is provided with a switch for controlling the power. DC power supply will not cause a LED strobe of AC. LED strobe is not only harmful to babies', but also to adults' vision.

Preferably, wherein the DC power comprises a battery box fixed on the inner wall of the bottom cover, the battery box contains the batteries, and the battery box cover is closed on the opening of the battery box, the batteries can be dry battery, rechargeable battery or solar cells, the battery box cover can be replaced by a solar panel, the switch comprises the power button, the bottom plate and the bottom plate positioning slot, the bottom plate is fixed on the inner wall of the back side of the box body through the bottom plate positioning slot, the power button is mounted on the bottom plate, the back side of the box body is provided with a reserved hole for the power button to match the power button.

Preferably, the power button can use a touch button if needed, the illuminant of this product has a gear switch. The product function logic is as follows: 1, hold the power button for 3 seconds, the light will increase from 5% brightness; 2, clicking the power button one more time could shut down the lights when the light is on; 3, to click the power button when the power is off, the product starts to work, the lights brightness will be automatically maintained the brightness of the last turn-off; 4, even if the lights are working, hold the power button for three seconds again, the product will re-enter the mode 1. It meets the requirements of various use conditions.

Preferably, wherein further comprises a transparent shield provided on the front side of the open box body, the left side, the right side and the upper side of the open box body and one end of the bottom cover are provided with reserved slots matched with the transparent shield, the transparent shield is detachably connected with the open box body and the bottom cover through the reserved slots.

Preferably, wherein screw columns are arranged on the upper side of an open box body, positioning columns of bottom cover is arranged on the inner wall of the bottom cover which matches the screw columns, screw holes are arranged on the positioning columns of bottom cover, screws are used to keep the bottom cover with the open box body.

Preferably, the two precise lighting paths of the first luminous assembly and the second luminous assembly is interested and distributed as an X shaped. Preferably, the two lighting paths may become the cluster point which is located 20-25 cm in front of the illuminant loading plate.

Compared with the prior art, the present invention has the following benefits: the eye-friendly illumination spotlight used for cleaning the baby's excreta at night has soft lighting, the two precise lighting paths of the first luminous assembly and the second luminous assembly is interested and distributed as an X shaped. The two lighting paths are integrated by the lens and the light shield so as to intersect an X-shaped lighting path 20-25 cm in front of the open box body. If the box is placed in front of the baby's buttocks, the cluster point is formed near the baby's buttocks. The lighting is good for shining the baby's buttocks and is dispersed and reduced rapidly after clustering. When using, it will not cause a direct shining the baby's eyes, and will not affect the baby's sleeping, more will not injure the baby's vision. It can meet the requirements of the lighting for parents changing the nappy at night and cleaning the baby's extract, and is convenient to use. Even if the lighting deviates unexpectedly in use, the intensity of the lighting path shining on the baby's head is only 50% of the total intensity of two lighting paths, in addition, the illuminant is far away from the baby's head, the lighting intensity on point of the baby's eyes is felt very small, very safe. DC power supply will not cause a LED strobe of AC. LED strobe is not only harmful to babies', but also to adults' vision. The joint between the transparent shield and the box body is located on the side of the box. Even if excrement sprays in use, dirt adheres to the transparent shield. Timely cleaning of the transparent shield will not damage the box, and is very convenient to clean.

### BRIEF DESCRIPTION OF FIGURES IN THE DRAWINGS

In order to explain more clearly the specific embodiments of the invention or the technical schemes in prior art, a brief description of the drawings used in the specific embodiments or in prior art is introduced below. In all drawings, similar reference numbers generally identifies similar elements or parts. In drawings, the elements or parts are not necessarily drawn to the actual scale.

FIG. 1 is an external stereogram I of the specific embodiment of the invention;

FIG. 2 is an external stereogram II after removing transparent shield of the specific embodiment of the invention;

FIG. 3 is an interior schematic I of the specific embodiment of the invention;

FIG. 4 is an interior schematic II of the specific embodiment of the invention;

FIG. 5 is an interior schematic III of the specific embodiment of the invention;

FIG. 6 is an interior schematic IV of the specific embodiment of the invention;

FIG. 7 is an enlarged structure schematic of the illuminant loading plate of the specific embodiment of the Invention;

FIG. 8 is an enlarged structure schematic of the bottom cover of the specific embodiment of the Invention;

FIG. 9 is a schematic of lighting path of the specific embodiment of the Invention.

### REFERENCE NUMBERS

1 open box body,

2 bottom cover

3 illuminant loading plate

4 illuminant loading plate slot

5 lens A

6 lens B

7 lamp bead A

8 lamp bead B

9 PCB plate A

10 PCB plate B

11 PCB plate and the lens positioning column

12 positioning column of bottom cover

13 power button

14 switch bottom plate

15 positioning slot of switch bottom plate

16 battery box

17 battery box cover

18 transparent shield

19 reserved slot of transparent shield

20 light shield A

21 light shield B

22 transparent window A

23 transparent window B

24 screw hole

25 screw column

26 lighting path of the first luminous assembly

27 lighting path of the second luminous assembly

28 cluster point

### MODE(S) FOR CARRYING OUT THE INVENTION

The present invention is further described with reference to certain drawings:

The invention is further explained by specific embodiments below, but need not be limited to the invention. Any modification, equivalent replacement, improvement etc. made within the spirit and principles of the invention shall be included in the protection scope of the invention.

### Embodiment

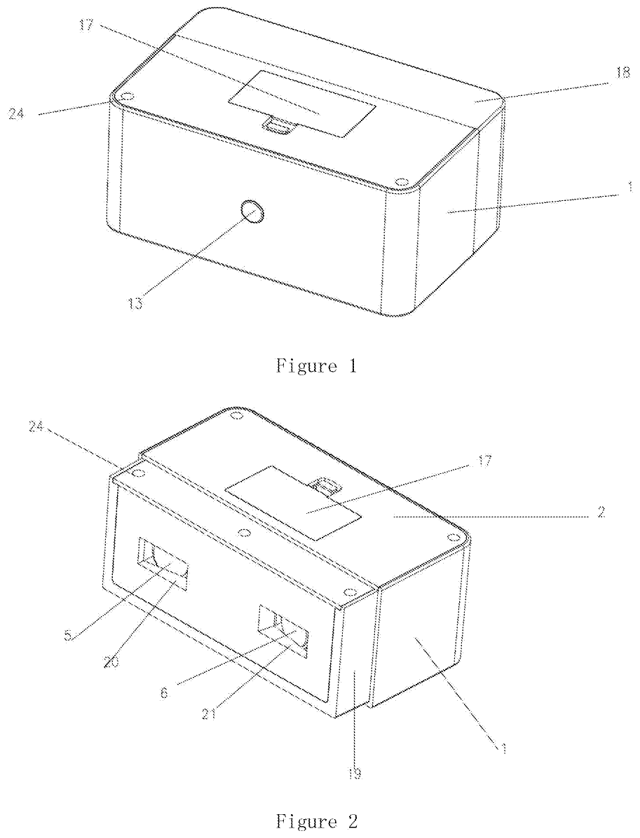

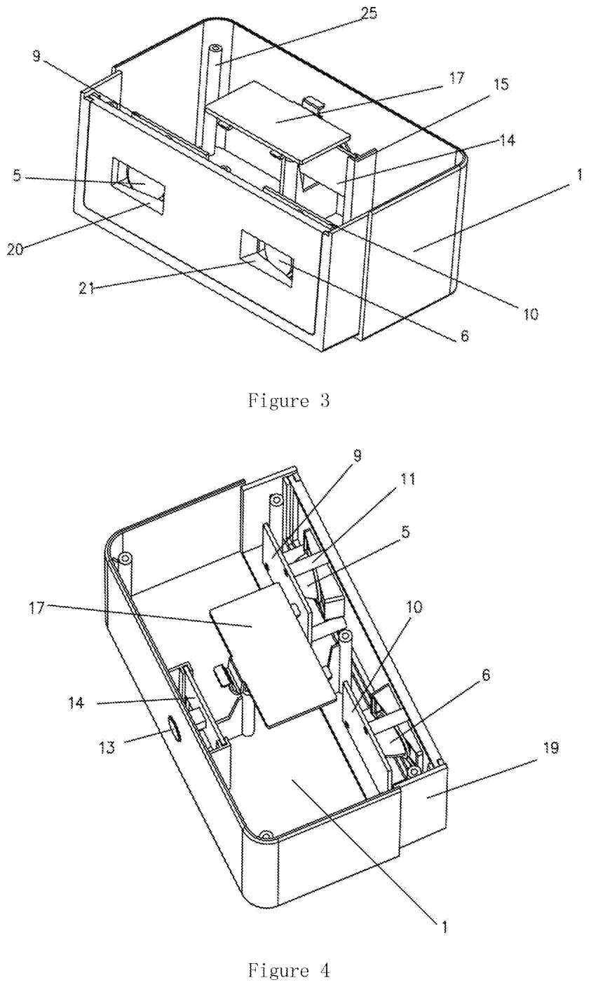

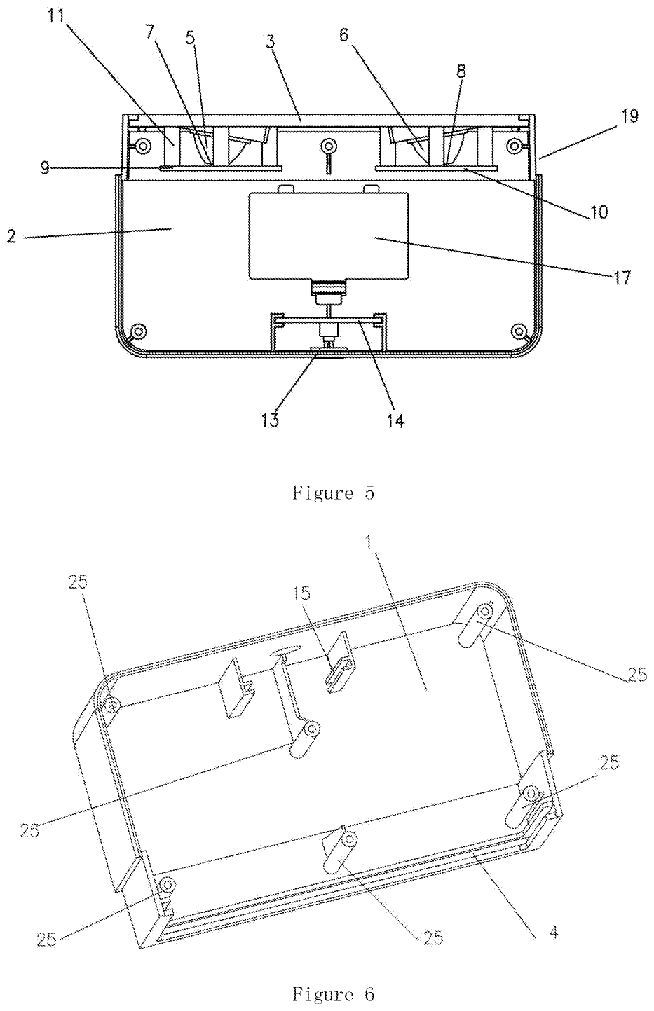

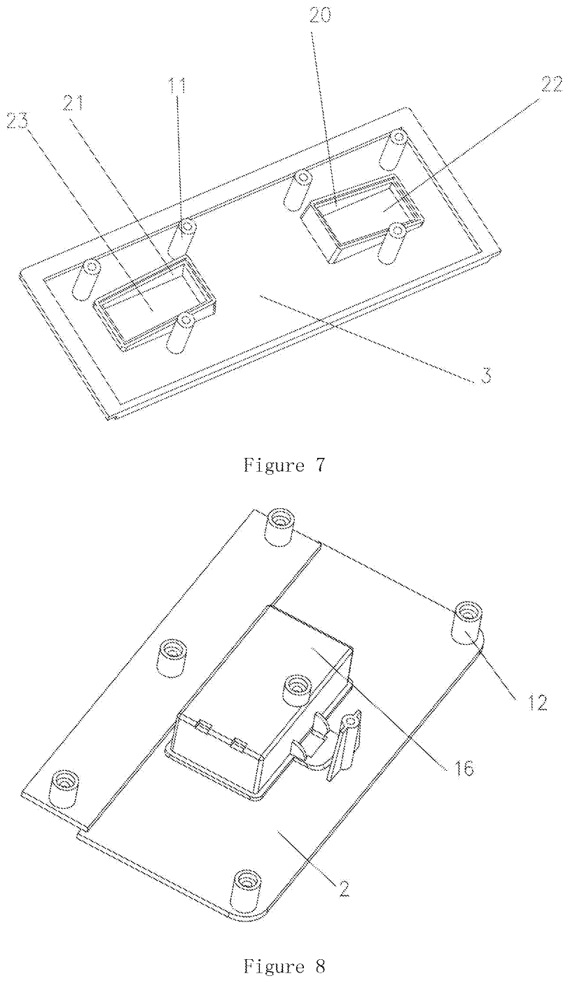

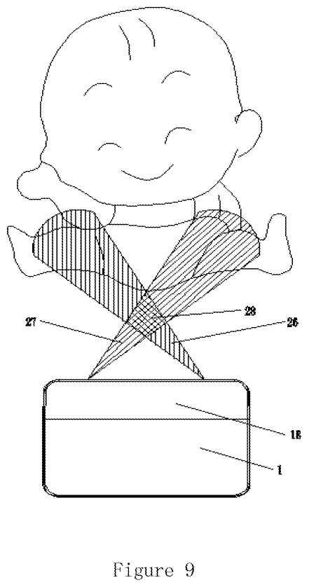

Shown in FIGS. 1-9, the eye-friendly illumination spotlight used for cleaning the baby's excreta at night, comprising an open box body 1 with an opening at bottom, the bottom opening of the open box body 1 being mounted with a detachable bottom cover 2, wherein the open box body 1 comprises a front side of the box body detachably arranged on the open box body, the inner wall of the front side of the box body is fixedly provided with a first luminous assembly and a second luminous assembly arranged symmetrically, the front side of the box body is provided with a transparent window A 22 matched with the first luminous assembly and a transparent window B 23 matched with the second luminous assembly, the lighting path 26 of the first luminous assembly intersects the lighting path 27 of the second luminous assembly to form an X-shaped lighting path, and a lighting cluster point 28 is formed in front of the lamp box.

In this case, wherein the front side of the box body comprises an illuminant loading plate 3, two ends and the top of the illuminant loading plate are respectively arranged with a first insert plate, a second insert plate and a third insert plate, the open box body 1 is arranged with the illuminant loading plate slots 4 connected with the first insert plate, the second insert plate and the third insert plate. Wherein the first luminous assembly comprises a PCB plate A9 arranged inside the open box body 1 and equipped with a control circuit to control the illuminant, an illuminant A connected with the PCB plate A9, and a lens A5 clamped between the illuminant loading plate 3 and the PCB plate A9 to gather the light beam of the illuminant A for irradiation; the second luminous assembly comprises a PCB plate B10 arranged inside the open box body 1 and equipped with a control circuit to control the illuminant, an illuminant B connected with the PCB plate B10, and a lens B6 clamped between the illuminant loading plate and the PCB plate B10 to gather the light beam of the illuminant B for irradiation. Wherein the illuminant A is a lamp bead A7, the illuminant B is a lamp bead B8, the lamp bead A7 and the lamp bead B8 are LED beads, the color temperature of LED beads is less than 3000K; wherein the PCB plate A9 and the PCB plate B10 are detachable mounted on the illuminant loading plate 3 respectively through the corresponding PCB plates and the lens positioning column 11. Wherein the transparent window A22 is integrated with a light shield A20, the light shield A20 is located on the illuminant loading plate 3, the transparent window B23 is integrated with a light shield B21, the light shield B21 is located on the illuminant loading plate 3, the light shield A20 and the light shield B21 further integrate the light path from the lens and filter stray light, so that the lighting path of the first luminous assembly 26 and the lighting path of the second luminous assembly 27 project more accurately. Wherein the inner wall of the bottom cover 2 is provided with a DC power for providing energy for the lamp beads A7 and B8, the lamp beads A7 and B8 are electrically connected with the DC power, the back side of the open box body 1 is provided with a switch for controlling the power. Wherein the DC power comprises a battery box 16 fixed on the inner wall of the bottom cover 2, the battery box 16 contains the batteries, and the battery box cover 17 is closed on the opening of the battery box 16, the batteries can be dry battery, rechargeable battery or solar cells, the battery box cover 17 can be replaced by a solar panel, the switch comprises the power button 13, the bottom plate 14 and the bottom plate positioning slot 15, the bottom plate 14 is fixed on the inner wall of the back side of the box body through the bottom plate positioning slot 15, the power button 13 is mounted on the bottom plate 14, the back side of the box body is provided with a reserved hole for the power button 13 to match the power button 13. The illuminant of this product has a gear switch. When the power is off, the product starts to work by pressing the power button 13 once. Low power will be activated by pressing the power button 13 twice. The high power will be activated by pressing the power button 13 thrice. Clicking the power button 13 one more time can shut down the light when the light is on. It meets the requirements of various use conditions. Wherein further comprises a transparent shield 18 provided on the front side of the open box body 1, the left side, the right side and the upper side of the open box body 1 and one end of the bottom cover 2 are provided with reserved slots 19 matched with the transparent shield 18, the transparent shield 18 is detachable connected with the open box body 1 and the bottom cover 2 through the reserved slot of transparent shield 19. Wherein screw columns 25 are arranged on the upper side of an open box body 1, positioning columns of bottom cover 12 is arranged on the inner wall of the bottom cover 2 which matches the screw columns 25, screw holes 24 are arranged on the positioning columns of bottom cover 12, screws are used to keep the bottom cover 2 with the open box body 1.

The working principle of this product is that the lamp bead A7 is fixed on the PCB board A9, the lens A5 is fixed on the PCB board A9 and combined with the lamp bead A7, the PCB board A9 is fixed on the illuminant loading plate 3 with three screws, and the lamp bead B8, the lens B6 and the PCB board B10 are fixed on the illuminant loading plate 3 in the same way. The illuminant loading plate 3 which is a detachable piece is fixed in the illuminant loading plate slot 4 which is a part of the open box body 1. The power button 13 is placed in the reserved hole of the power button, and the switch bottom plate 14 is placed into the positioning slot of switch bottom plate 15. The next step is to connect PCB plate A9, PCB plate B10, power button 13 and battery with electronic wires. The bottom cover 2 is screwed on the positioning column of bottom cover 12 of open box body 1. Put the transparent cover 18 on the reserved slot of transparent shield 19 to complete product assembly.

The LED patch bead A7 and B8 of this product emit two lighting paths which are adjusted by lens A5 and lens B6. And then, those two lighting paths are filtered by light shield A20 and light shield B21 and emitted from transparent cover 18. Even if the lighting deviates unexpectedly in use, the intensity of the lighting path shining on the baby's head is only 50% of the total intensity of two lighting paths, in addition, the illuminant is far away from the baby's head, the lighting intensity on point of the baby's eyes is felt very small, very safe. The head of the baby is in the dark area because the light path is X-shaped. Therefore, the product will not affect the baby's sleep. Compared with the structure of traditional lighting resources, this product has incomparable advantages.

The above shows and describes the basic principle, features and advantages of the invention. The skilled person in the art can know that the present invention is not limited by the above embodiment, the embodiment and the description only explain the basic principle. Without departing from the spirit and scope of the present invention, various changes and improvements are included in the present application, which fall within the protection scope of the invention. The protection range is defined by the claims and its equivalents.

I claim:

1. An eye-friendly illumination spotlight used for cleaning the baby's excreta at night, characterized in that: comprising an open box body with an opening at bottom, the bottom opening of the open box body being mounted with a detachable bottom cover, wherein the open box body comprises a front side of the box body detachably arranged on the open box body, the inner wall of the front side of the box body is fixedly provided with a first luminous assembly and a second luminous assembly arranged symmetrically, the front side of the box body is provided with a transparent window A matched with the first luminous assembly and a transparent window B matched with the second luminous assembly, the lighting path of the first luminous assembly intersects the lighting path of the second luminous assembly to form an X-shaped lighting path, and a cluster point of lightings is formed in front of the lamp box.

2. The eye-friendly illumination spotlight used for cleaning the baby's excreta at night according to claim 1, wherein the front side of the box body comprises an illuminant loading plate, two ends and the top of the illuminant loading plate are respectively arranged with a first insert plate, a second insert plate and a third insert plate, the open box body is arranged with the illuminant loading plate slots connected with the first insert plate, the second insert plate and the third insert plate.

3. The eye-friendly illumination spotlight used for cleaning the baby's excreta at night according to claim 2, wherein the first luminous assembly comprises a PCB plate A arranged inside the open box body and equipped with a control circuit to control the illuminant, an illuminant A connected with the PCB plate A, and a lens A clamped between the illuminant loading plate and the PCB plate A to gather the light beam of the illuminant A for irradiation; the second luminous assembly comprises a PCB plate B arranged inside the open box body and equipped with a control circuit to control the illuminant, an illuminant B connected with the PCB plate B, and a lens B clamped between the illuminant loading plate and the PCB plate B to gather the light beam of the illuminant B for irradiation.

4. The eye-friendly illumination spotlight used for cleaning the baby's excreta at night according to claim 3, wherein the illuminant A is a lamp bead A, the illuminant B is a lamp bead B, the lamp bead A and the lamp bead B are LED beads, the color temperature of LED beads is less than 3000K, the light is warm and soft, which is helpful to reduce eye irritation at night.

5. The eye-friendly illumination spotlight used for cleaning the baby's excreta at night according to claim 4, wherein the PCB plate A and the PCB plate B are detachably mounted on the illuminant loading plate respectively through the corresponding PCB plates and the lens positioning column.

6. The eye-friendly illumination spotlight used for cleaning the baby's excreta at night according to claim 5, wherein the transparent window A is integrated with a light shield A, the light shield A is located on the illuminant loading plate, the transparent window B is integrated with a light shield B, the light shield B is located on the illuminant loading plate, the light shield A and the light shield B further integrate the light path from the lens and filter stray light, so that the lighting path of the first luminous assembly and the lighting path of the second luminous assembly project more accurately.

7. The eye-friendly illumination spotlight used for cleaning the baby's excreta at night according to claim 6, wherein the inner wall of the bottom cover is provided with a DC power for providing energy for the lamp beads A and B, the lamp beads A and B are electrically connected with the DC power, the back side of the open box body is provided with a switch for controlling the power.

8. The eye-friendly illumination spotlight used for cleaning the baby's excreta at night according to claim 7, wherein the DC power comprises a battery box fixed on the inner wall of the bottom cover, the battery box contains the batteries, and the battery box cover is closed on the opening of the battery box, the batteries can be dry battery, rechargeable battery or solar cells, the battery box cover can be replaced by a solar panel, the switch comprises the power button, the bottom plate and the bottom plate positioning slot, the bottom plate is fixed on the inner wall of the back side of the box body through the bottom plate positioning slot, the power button is mounted on the bottom plate, the back side of the box body is provided with a reserved hole for the power button to match the power button.

9. The eye-friendly illumination spotlight used for cleaning the baby's excreta at night according to claim 8, wherein further comprises a transparent shield provided on the front side of the open box body, the left side, the right side and the upper side of the open box body and one end of the bottom cover are provided with reserved slots matched with the transparent shield, the transparent shield is detachably connected with the open box body and the bottom cover through the reserved slots.
